(19) United States
(12) Patent Application Publication
(10) Pub. No.: US 2024/0070117 A1
(43) Pub. Date: Feb. 29, 2024

(54) METHOD AND SYSTEM OF MODIFYING INFORMATION ON FILE

(71) Applicant: CDK GLOBAL, LLC, Hoffman Estates, IL (US)

(72) Inventor: Marc Hines, Portland, OR (US)

(21) Appl. No.: 17/823,930

(22) Filed: Aug. 31, 2022

(51) Int. Cl. G06F 16/16; G06F 16/14

(52) U.S. Cl. CPC G06F 16/164; G06F 16/148

(57) ABSTRACT

Systems and computer-implemented methods and systems for modifying information in a document file are disclosed. An example computer-implemented method for modifying information in a document file includes: receiving a first text string; opening a file corresponding to the first text string, the file including binary data and text data; reading the text data; detecting a file location identifier in the text data; replacing a portion of the file location identifier with a second text string based on the first text string; and closing the file.

### BACKGROUND

The present disclosure relates to modification of information on a file. In particular, the present disclosure relates to modification of address information on a file.

Embedding a document file, such as a file in a portable document format (.pdf), in software applications and websites has proven to be an effective technique for sharing information with users of the software applications and visitors of the websites. However, when the information in the embedded document file becomes obsolete, the document file may need to be regenerated. If the information shared by the document file is similar, but not identical depending on target users and/or target subjects/objects of interests, the document file may need to be generated for each user/subject/object. Such regeneration of the document file or each generation of the document file for each user/subject/object using document creation/modification software is cumbersome and time consuming. Thus, more effective and efficient document modification and/or updating methods and tools are desired.

### BRIEF DESCRIPTION OF THE DRAWINGS

FIG. 1 is a block diagram of an example system of modifying information in a document file according to an embodiment of the present disclosure.

FIG. 2 is a flowchart of an example method of modifying information in a document file according to an embodiment of the present disclosure.

FIG. 3A shows an example of modification of information in a document file according to an embodiment of the present disclosure.

FIG. 3B shows an example of modification of information in a document file according to an embodiment of the present disclosure.

FIG. 4 is a block diagram of an example system of modifying information in a document file according to an embodiment of the present disclosure.

FIG. 5 is a flowchart of an example method of creating information for modification in a document file according to an embodiment of the present disclosure.

FIG. 6 shows an example of modification of information in a document file according to an embodiment of the present disclosure.

FIG. 7 is a flowchart of an example method of creating information for modification in a document file according to an embodiment of the present disclosure.

FIG. 8 is a block diagram of an example system of modifying information in a document file according to an embodiment of the present disclosure.

FIG. 9 is a flowchart of an example method of obtaining information for modification in a document file according to an embodiment of the present disclosure.

### DETAILED DESCRIPTION

Various embodiments of the present disclosure will be explained below in detail with reference to the accompanying drawings. The following detailed description refers to the accompanying drawings that show, by way of illustration, specific aspects and embodiments of the disclosure. The detailed description includes sufficient detail to enable those skilled in the art to practice the embodiments of the disclosure. Other embodiments may be utilized, and structural, logical, and electrical changes may be made without departing from the scope of the present disclosure. The various embodiments disclosed herein are not necessary mutually exclusive, as some disclosed embodiments can be combined with one or more other disclosed embodiments to form new embodiments. Thus, the following more detailed description of the embodiments of the systems, methods, and apparatuses is not intended to limit the scope of the disclosure, but is merely representative of possible embodiments of the disclosure. In some cases, well-known structures, materials, or operations are not shown or described in detail.

The present disclosure provides various embodiments of replacing file location information in a document file. According to various embodiments, a portion of a file location information, such as a path, a combination of a path and a portion of a file name in a document file or a data file may be updated. For example, updating from an old path to a new path, updating a temporary path and a temporary file name to an actual path, or updating to a path name and a file name specific to a category or specific to a user may be performed. Without activating an application that accesses a complex file, such as a portable document file with a file extension .pdf, the file location information may be updated throughout the complex file, and/or across complex files.

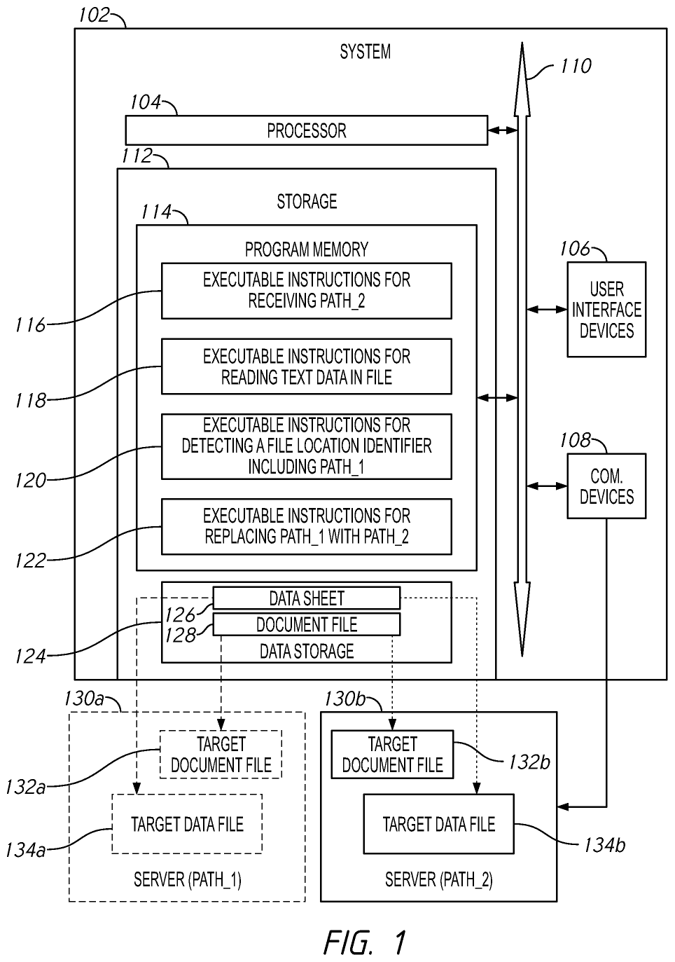

FIG. 1 is a block diagram of an example system 102 of modifying information in a document file according to an embodiment of the present disclosure. In some embodiments, the system 102 may be a computer including a processor 104, a storage 112, user interface devices 106, communication devices 108 and a bus 110. The processor 104 may access the storage 112, the user interface devices 106, and the communication devices 108 through the bus 110. The user interface devices 106 may include input devices that accept entries by a user, and output devices that provide information to the user. The input devices may include, for example, a mouse, a keyboard, a microphone and/or a camera. The output devices may include, for example, a display, one or more speakers, a printer, etc. The storage 112 may include program memory 114 that may store instructions to be executed by the processor 104. The storage 112 may also include a data storage 124 that may store data. The communication devices 108 may include hardware, software, or both providing one or more interfaces for communication (such as, for example, packet-based communication) between the system 102 and one or more other computers, such as a server 130b via one or more networks by wireless or wired internet/intranet communications. The wireless communications may include, for example, Wi-Fi, a cellular telecommunication such as CDMA, GSM, EV-DO, 3G, 4G, and 5G, etc., a short distance communication such as Bluetooth, near filed communications (NFC), etc. The wired communications may include communication via an Ethernet, etc.

The processor 104 may include hardware for executing instructions, such as those stored in the program memory 114 of the storage 112. The program memory 114 may include executable instructions that may be executed by the processor 104. In some embodiments, the executable instructions stored in the program memory 114 may include executable instructions for receiving path_2 116, executable instructions for reading text data in file 118, executable instructions for detecting a file location identifier including path_1 120, and executable instructions for replacing path_1 120 with path_2 122. In some embodiments, the executable instructions stored in the program memory 114 may be implemented as a file including a script code that executes file editing commands.

The processor 104 may perform replacement of path in a link in a file stored in the storage 112 from an old path PATH_1 to a new path PATH_2. For example, the file stored in the storage 112 may be a document file 128 or a data sheet 126. In some embodiments, the document file 128 may be a word format file with a file extension, such as .doc, .docx, .dot, a portable document file with a file extension .pdf, etc. In some embodiments, the data sheet 126 may have a file extension .xls. However, the file may be any file that includes text strings. In FIG. 1, the document file 128 and the data sheet 126 may include links to a target document file 132a and a target data file 134a on a server 130a, respectively. The links to the target document file 132a and the target data file 134a may include an old path PATH_1 that is a path indicative of a file location on the server 130a. In some embodiments, the server 130a may be an old server where these target data and document files are transferred from. In some embodiments, the server 130a may be an imaginary server and the old path PATH_1 may be an imaginary path or a temporary path that is a place holder in the data sheet 126 and/or the document file 128.

The path in the link is replaced with the new path PATH_2 that is a path indicative of a file location on the server 130b. After the replacement, the document file 128 may include a link to a target document file 132b and the data sheet 126 may include a link to a target data file 134b on the server 130b. In some embodiments, the server 130b may be a new server where these target data and document files are transferred to. In some embodiments, the server 130b may be a real server and the new path PATH_2 may be an actual path. In some embodiments, the new path PATH_2 may be provided from another application in the system 102. In some embodiments, the new path PATH_2 may be provided from another application on another computer that updates a path as a part of updating a system, which may be communicated via one of the communication devices 108. In some embodiments, the new path PATH_2 may be provided by an operator that may manually enter the new path PATH_2 using one of the user interface devices 106.

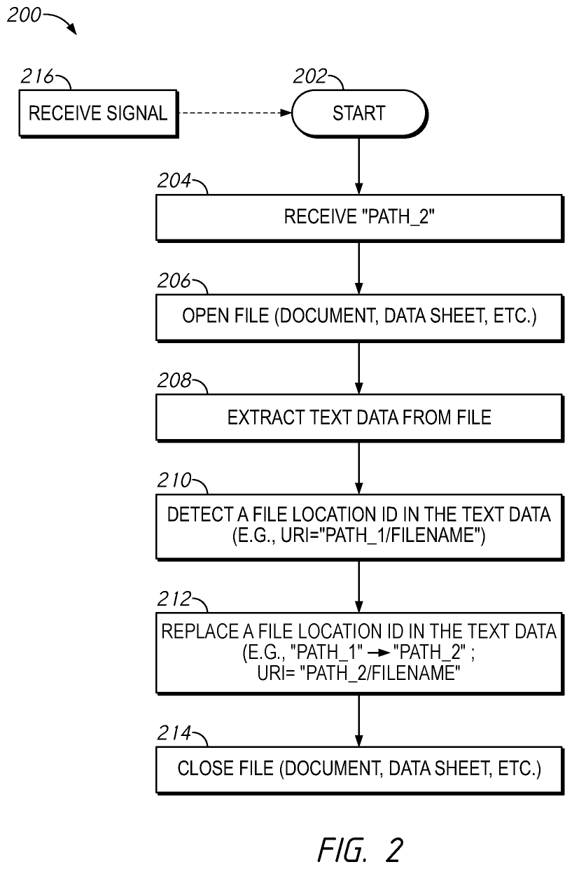

FIG. 2 is a flowchart of an example method 200 of modifying information in a document file according to an embodiment of the present disclosure. In some embodiments, the method 200 may be performed on the system 102 of FIG. 1. In some embodiments, the executable instructions stored in the program memory 114 may be implemented as a file including a script code that executes file editing commands. The method 200 may start at step 202 responsive to a signal received at step 216. In some embodiments, the signal may be received from a file manager application. For example, the file manager application may be an application either on the system 102 or on another computer providing the signal through the communication devices 108. In some embodiments, the file managing application may be implemented as a script including editing commands to instruct the processor 104 to perform replacement of file location information. The signal may be indicative of an update of a file location information due to files transferred from one server to another server. In some embodiments, the signal may be based on a user entry at the user interface devices 106. The user entry may be provided by an operator that may manually enter the new path PATH_2 using the user interface devices 106. Responsive to the signal, the processor 104 may perform the executable instructions for receiving path_2 116 to receive a new path PATH_2 at step 204.

The processor 104 may perform the executable instructions for reading text data in file 118 on the system 102. The processor 104 may open the file in step 206. For example, the file may be the document file 128 or the data sheet 126. The file may include data, including a text portion and a binary portion. The processor 104 may extract the text portion of the data in step 208. In some embodiments, the processor 104 may parse data in the file, interpret metadata in the parsed data, and extract text strings per the executable instructions for reading text data in file 118.

The processor 104 may perform the executable instructions for detecting a file location identifier including path_1 120 in step 210. In some embodiments, the processor 104 may further parse the extracted text strings and detect the file location identifier. For example, “/” signals that a tag follows after “/”. Once the processor 104 detects “/” in the document file 128, then the processor 104 may detect a tag “URI” for a uniform resource identifier (URI) after “/”. The tag “URI” may signal that a URI follows. After detecting the URI, the processor 104 may detect inside parentheses “(” and “)” as the file location identifier. In some embodiments, the file location identifier may include an application-layer protocol, such as “http://” indicative of the Hypertext Transfer Protocol (HTTP). A text string following the application-layer protocol may indicate a path and a file name of a target file. By using the file location identifier, a location of the old target file either inside or outside the system 102 may be addressed.

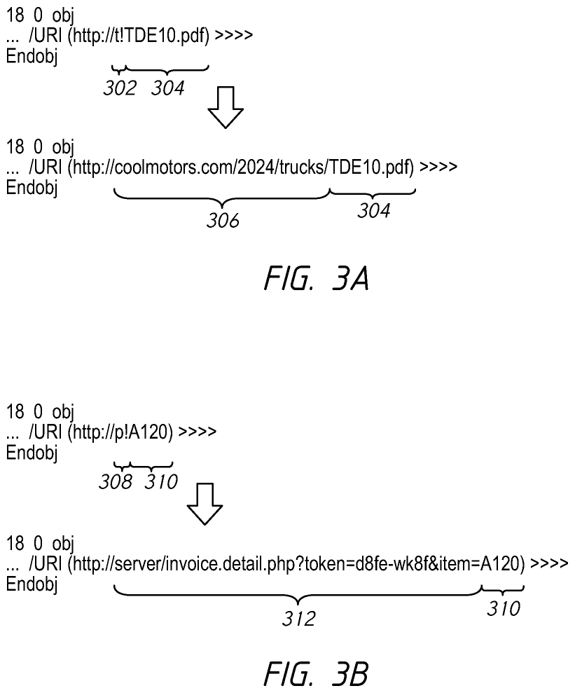

FIG. 3A is an example of modification of information in a document file 128 according to an embodiment of the present disclosure. For example, the processor 104 may detect a text string “http://t!TDE10.pdf” inside parentheses “(” and “)” as the file location identifier. Based on a separator (e.g., “!”) between a path 302 and a file name 304, the processor 104 may also detect “t!” as the path 302 (e.g., PATH_1) and the file name 304 “TDE10.pdf.”

The processor 104 may perform the executable instructions for replacing path_1 120 with path_2 122 in step 212. For example, the processor 104 may replace the path 302 “t!” with a new path 306 “sparkymotors.com/2023/.” Then the document file 128 now includes an updated file location identifier that is a new URI, “http://sparkymotors.com/2023/TDE10.pdf” to identify a target file on a new server. After replacing the path 302 with the new path 306, the processor 104 may close the file in step 214.

The scope of replacement may not be limited to a path. A combination of a path and a file name can be replaced. FIG. 3B is another example of modification of information in a document file 128 according to an embodiment of the present disclosure. For example, a text string “http://p!A120” inside parentheses “(” and “)” may be detected as the file location identifier. Based on a separator (e.g., “!”) between a first portion 308 and a second portion 310 of the file location identifier, a text string “p!” may be detected as the first portion 308 of the file location identifier and a text string “A120” may be detected as the second portion 310 of the file location identifier.

The processor 104 may perform the executable instructions for replacing the first portion 308 of the file location identifier with a new first portion 312. For example, the processor 104 may replace the first portion 308 “p!” with the new first portion 312 “server/invoice.detail.php?token=d8fe-wk8f&item=.” Then the document file 128 now includes an updated file location identifier that is a new URI, “http://server/invoice.detail.php?token=d8fe-wk8f&item=A120,” to identify a target file on a new server.

The method 200 of modifying information in a document file has been described above. However, a scope of modifying information may not be limited to a single file. For example, a script describing the method 200 may access multiple files and perform the method 200 to replace file location information across the multiple files. Thus, file location changes common to several items within a single file or across multiple files may be performed by executing the script without having the application to access the multiple files.

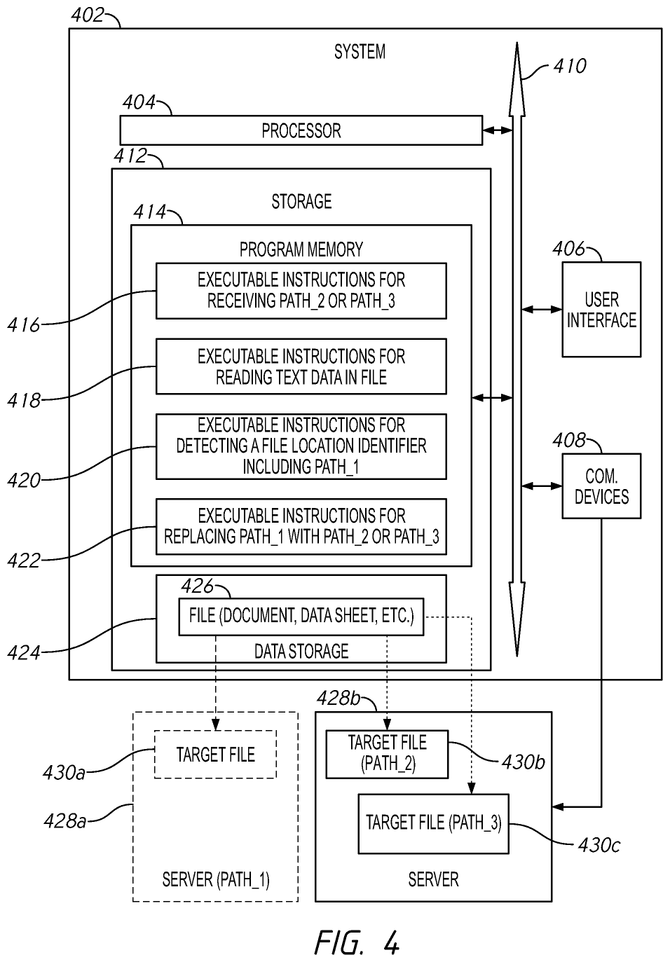

FIG. 4 is a block diagram of an example system 402 of modifying information in a document file according to an embodiment of the present disclosure. In some embodiments, the system 402 may be a computer including a processor 404, a storage 412, user interface devices 406, communication devices 408, and a bus 410. The processor 404, the storage 412, the user interface devices 406, the communication devices 408, and the bus 410 may include any of the features of the processor 104, the storage 112, the user interface devices 106, the communication devices 108, and the bus 110, respectively. Thus, a detailed description of functionalities of the processor 404, the storage 412, the user interface devices 406, the communication devices 408, and the bus 410, which have been previously described referring to FIG. 1, is therefore not repeated herein for brevity. The storage 412 may include a program memory 414 and a data storage 424.

The processor 404 may include hardware for executing instructions, such as those stored in the program memory 414 of the storage 412. The program memory 414 may include executable instructions that may be executed by the processor 404. In some embodiments, the executable instructions stored in the program memory 414 may include executable instructions for receiving path_2 or path_3 416, executable instructions for reading text data in file 418, executable instructions for detecting a file location identifier including path_1 420, and executable instructions for replacing path_1 420 with path_2 or path_3 422. In some embodiments, the executable instructions stored in the program memory 414 may be implemented as a file including a script code that executes file editing commands.

The processor 404 may perform replacement of path in a link in a file 426 stored in the data storage 424 from an old path PATH_1 to a new path PATH_2 or another new path PATH_3. For example, the file 426 stored in the data storage 424 may be a document file, a data sheet, etc. The file 426 may be any file that includes text strings. In FIG. 4, the file 426 may include a link to a target file 430a on a server 428a. The link to the target file 430a may include an old path PATH_1 that is a path indicative of a file location on the server 428a. In some embodiments, the server 428a may be an imaginary server and the old path PATH_1 may be an imaginary path or a temporary path that is a place holder in the file 426.

The path in the link is replaced with either the new path PATH_2 or PATH_3. The new path PATH_2 or PATH_3 may be an actual path or a permanent path. In some embodiments, the new paths PATH_2 and PATH_3 in FIG. 4 are located on the same server 428b; however, the new paths PATH_2 and PATH_3 may be located on different servers. After the replacement, the file 426 may include a link to a target file 430b including the new path PATH_2 or a link to a target file 430c including the new path PATH_3 depending on different conditions.

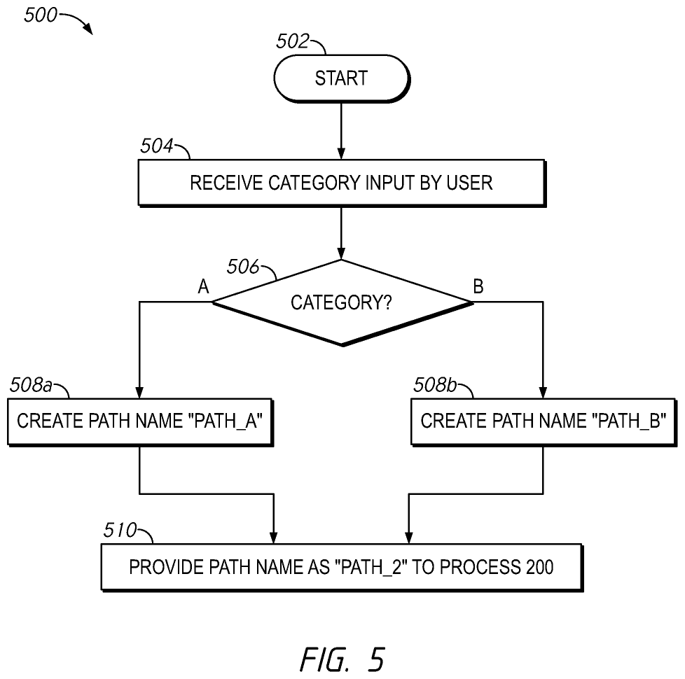

In some embodiments, the new paths PATH_2 and PATH_3 may be assigned based on an identifier of the user. FIG. 5 is a flowchart of an example method 500 of creating information for modification in a document file 426 according to an embodiment of the present disclosure. In some embodiments, the method 500 may be implemented in the executable instructions for receiving path_2 or path_3 416. The method 500 of creating information for modification starts in step 502 responsive to instructions in the executable instructions for receiving path_2 or path_3 416. In step 504, a user may access the system 402 by providing a target category of interest via the user interface devices 406. The system 402 may receive the user entry at the user interface devices 406.

In step 506, the processor 404 may determine what category has been entered by the user. If the category is A, then the processor 404 may proceed to perform step 508a. If the category is B, then the processor 404 may proceed to perform step 508b.

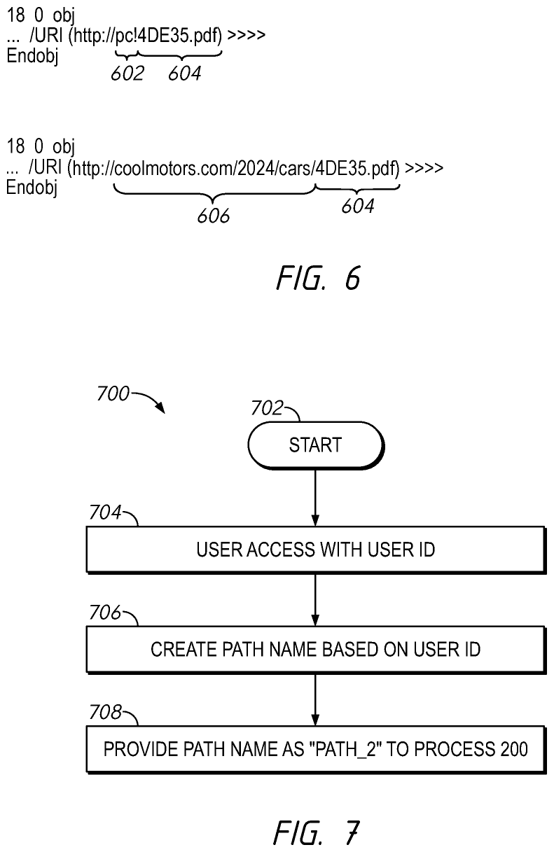

The processor 404 may create a path name based on the category. For example, if the category is “A,” a text string “coolmotors.com/2024/trucks/” may be created in step 508a as a new path 306 of FIG. 3A. If the category is “B,” a text string “coolmotors.com/2024/cars/” may be created in step 508b as a new path 602 of FIG. 6. In step 510, the processor 404 or the other processor outside the system 402 may provide the created path name as “PATH_2” to a process described as the method 200. In some embodiments, step 510 may be performed by modifying a path in a script including the executable instructions for receiving path_2 or path_3 416.

The processor 404 may perform the executable instructions for replacing the path 302 of the file location identifier with a new path 306. For example, the processor 404 may replace the path 302 “t!” with the new path 306 “coolmotors.com/2024/trucks/,” if the identifier is “A.” Then the file 426 now includes an updated file location identifier that is a new URI, “http://coolmotors.com/2024/trucks/TDE10.pdf.” Thus, the file 426 accessed by the user choosing the category “A” will have access to a document file indicated by the new URI. For example, the processor 404 may replace the path 602 “pc!” with a new path 606 “coolmotors.com/2024/cars/,” if the identifier is “B” while keeping a file name 604, “4DE35.pdf.” Then the file 426 now includes an updated file location identifier that is a new URI, “http://coolmotors.com/2024/cars/4DE35.pdf.” Thus, the file 426 accessed by the user choosing the category “B” will have access to a document file indicated by the new URI, different from the document file accessed by the user who chooses the category “A.”

In some embodiments, the new paths PATH_2 and PATH_3 may be assigned based on an identifier of the user. FIG. 7 is a flowchart of an example method 700 of creating information for modification in a document file 426 according to an embodiment of the present disclosure. In some embodiments, the method 700 may be implemented in the executable instructions for receiving path_2 or path_3 416. The method 700 of creating information for modification starts in step 702 responsive to instructions in the executable instructions for receiving path_2 or path_3 416. In step 704, a user may access the system 402 by providing an identifier of the user via the user interface devices 406. In some embodiments, the identifier of the user may be provided by a manual entry of the user such as a combination of login ID and password, biometric information, scanning of an ID code (e.g., a barcode, QR code, alphanumerical code, etc.). The system 402 may receive the user entry at the user interface devices 406.

In step 706, the processor 404 may create a path name based on the identifier of the user. For example, if the identifier of the user is “d8fe-wk8f,” a text string “server/invoice.detail.php?token=d8fe-wk8f&item=” may be created in step 706 as a new first portion 312 of FIG. 3B. If the identifier of the user is “9gk1-9wh4,” a text string “server/invoice.detail.php?token=9gk1-9wh4&item=” may be created in step 706 as a new first portion 312 of FIG. 3B. In step 708, the processor 404 or the other processor outside the system 402 may provide the created path name as “PATH_2” to a process described as the method 200. In some embodiments, step 708 may be performed by modifying a path in a script including the executable instructions for receiving path_2 or path_3 416.

The processor 404 may perform the executable instructions for replacing the first portion 308 of the file location identifier with a new first portion 312. For example, the processor 404 may replace the first portion 308 “p!” with the new first portion 312 “server/invoice.detail.php?token=d8fe-wk8f&item=,” if the identifier is “d8fe-wk8f.” Then the file 426 now includes an updated file location identifier that is a new URI, “http://server/invoice.detail.php?token=d8fe-wk8f&item=A120.” Thus, the file 426 accessed by the user with the identifier “d8fe-wk8f” will have access to an item indicated by the new URI. For example, the processor 404 may replace the first portion 308 “p!” with the new first portion 312 “server/invoice.detail.php?token=9gk1-9wh4&item=,” if the identifier is “9gk1-9wh4.” Then the file 426 now includes an updated file location identifier that is a new URI, “http://server/invoice.detail.php?token=9gk1-9wh4&item=A120.” Thus, the file 426 accessed by the user with the identifier “9gk1-9wh4” will have access to an item indicated by the new URI, different from the item accessed by the user having the identifier “d8fe-wk8f.”

FIGS. 5 and 7 described creating information for modifying the file location assigning the new paths PATH_2 and PATH_3 based on an item category or an identification of a user. However, the file location may be assigned based on some other information. For example, the new paths may be based on a time stamp of the location update (e.g., 2022, August), a time stamp of a user access, a location of a user (e.g., a region, a state, a country, a language), etc.

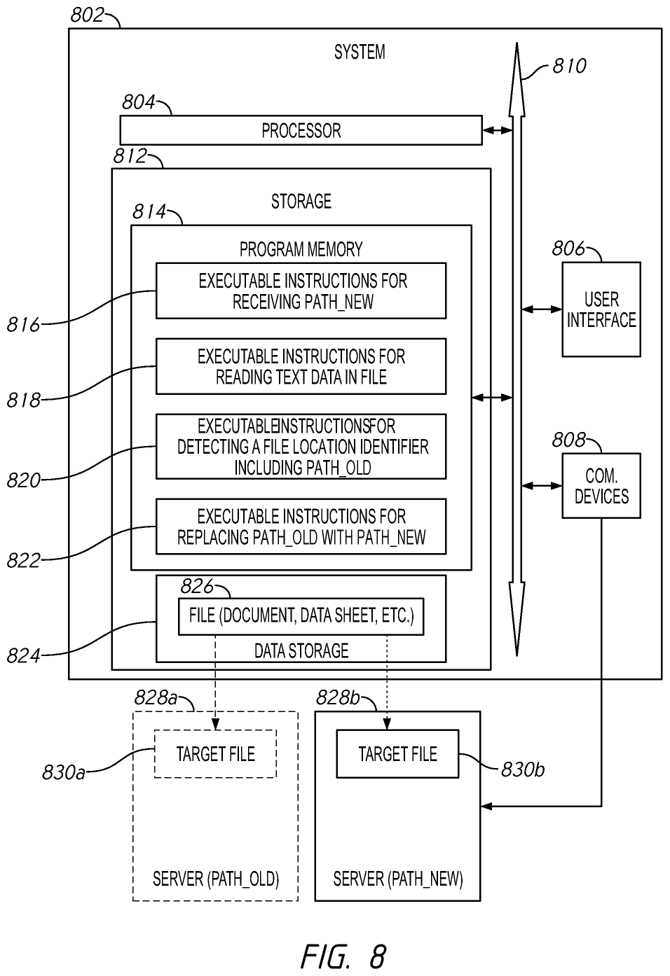

FIG. 8 is a block diagram of an example system 802 of modifying information in a document file according to an embodiment of the present disclosure. In some embodiments, the system 802 may be a computer including a processor 804, a storage 812, user interface devices 806, communication devices 808, and a bus 810. The processor 804, the storage 812, the user interface devices 806, the communication devices 808, and the bus 810 may include any of the features of the processor 104, the storage 112, the user interface devices 106, the communication devices 108, and the bus 110, respectively. Thus, a detailed description of functionalities of the processor 804, the storage 812, the user interface devices 806, the communication devices 808, and the bus 810, which have been previously described referring to FIG. 1, is therefore not repeated herein for brevity. The storage 812 may include a program memory 814 and a data storage 824.

The processor 804 may include hardware for executing instructions, such as those stored in program memory 814 of the storage 812. The program memory 814 may include executable instructions that may be executed by the processor 804. In some embodiments, the executable instructions stored in the program memory 814 may include executable instructions for receiving path_new 816, executable instructions for reading text data in file 818, executable instructions for detecting a file location identifier including path_old 820 and executable instructions for replacing path_old 820 with path_new 822. In some embodiments, the executable instructions stored in the program memory 814 may be implemented as a file including a script code that executes file editing commands.

The processor 804 may perform replacement of path in a link in a file 826 stored in the data storage 824 from an old path PATH_1 to a new path PATH_2. For example, the file 826 stored in the data storage 824 may be a document file, a data sheet, etc. The file 826 may be any file that includes text strings. In FIG. 8, the file 826 may include a link to a target file 830a on a server 828a. The link to the target file 830a may include an old path PATH_1 that is a path indicative of a file location on the server 828a. In some embodiments, the server 828a may be an old server where the target file 830a is outdated.

The path in the link is replaced with the new path PATH_2 that is a path indicative of a file location on a server 828b. After the replacement, the file 826 may include a link to a new target file 830b on the server 828b. In some embodiments, the server 828b may be a current server that is newer than the server 828a that stores files that are up-to-date.

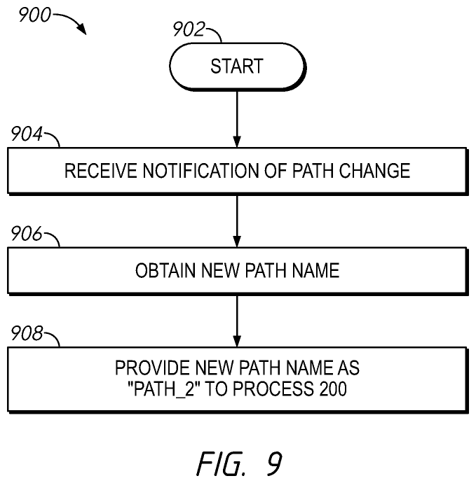

FIG. 9 is a flowchart of an example method 900 of obtaining information for modification in a document file 826 according to an embodiment of the present disclosure. In some embodiments, the method 900 may be implemented in the executable instructions for receiving path_new 816. The method 900 of creating information for modification starts in step 902 responsive to instructions in the executable instructions for receiving path_new 816. In some embodiments, a change to a new path may be notified by a file manager application on the same system or a different system in step 904 or from an operator manually.

In step 906, the processor 804 or another processor outside the system 802 may obtain a new path name responsive to the notification of the change to a new path. In step 908, the processor 804 or the other processor outside the system 802 may provide a new path name as “PATH 2” to a process described as the method 200. In some embodiments, step 908 may be performed by modifying a path in a script including the executable instructions for receiving path_new 816.

As described above, file location information in a document file may be replaced. A portion of file location information, such as a path, a combination of a path and a portion of a file name in a document file or a data sheet may be updated. Without activating an application that accesses a complex file including text data and binary data, such as a word document file, a portable document file, or a data sheet, the file location information may be updated throughout the complex file, and/or across complex files. Thus, updating from an old path to a new path, updating a temporary path and a temporary file name to an actual path, or updating to a path name and a file name specific to a category or specific to a user may be performed throughout the document file or the data sheet, or multiple files.

From the foregoing it will be appreciated that, although specific embodiments of the disclosure have been described herein for purposes of illustration, various modifications may be made without deviating from the spirit and scope of the disclosure. Accordingly, the scope of the disclosure should not be limited to any of the specific embodiments described herein.

What is claimed is:

1. A computer-implemented method of modifying information in a document file comprising:
receiving a first text string;
opening a file corresponding to the first text string, the file including binary data and text data;
reading the text data;
detecting a file location identifier in the text data;
replacing a portion of the file location identifier with a second text string based on the first text string; and
closing the file.

2. The method of claim 1, wherein the portion of the file location identifier is indicative of a first file location and the second text string is indicative of a second file location newer than the first file location.

3. The method of claim 1, wherein the portion of the file location identifier is indicative of a temporary path and the second text string is indicative of a permanent path.

4. The method of claim 1, wherein detecting the file location identifier in the text data comprises:
parsing the text data into one or more text strings; and
identifying a third text string including a tag among the one or more text strings,
wherein the tag indicates that a fourth text string following the third text string includes the file location identifier.

5. The method of claim 4, wherein the file is a portable document file (PDF).

6. The method of claim 1, further comprising receiving a signal indicative of a timing to update the portion of the file location identifier,
wherein receiving the first text string and opening the file are performed responsive to the signal.

7. The method of claim 6, wherein receiving the signal is responsive to a change of a location of the file,
wherein the second text string is indicative of a current location of the file.

8. The method of claim 6, wherein the second text string is based on an identifier of a user.

9. The method of claim 6, wherein the second text string is based on a category.

10. A non-transitory computer-readable medium storing executable instructions to perform a method of modifying information in a document file which, when executed by a processor, cause the processor to:
receive a first text string;
open a file corresponding to the first text string, the file including binary data and text data;
read the text data;
detect a file location identifier in the text data;
replace a portion of the file location identifier with a second text string based on the first text string; and
close the file.

11. The non-transitory computer-readable medium of claim 10, wherein the portion of the file location identifier is indicative of a first file location and the second text string is indicative of a second file location newer than the first file location.

12. The non-transitory computer-readable medium of claim 10, wherein the portion of the file location identifier is indicative of a temporary path and the second text string is indicative of a permanent path.

13. The non-transitory computer-readable medium of claim 10,
wherein the executable instructions which, when executed by the processor, cause the processor to detect the file location identifier in the text data comprise executable instructions which, when executed by the processor, cause the processor to:
parse the text data into one or more text strings; and
identify a third text string including a tag among the one or more text strings,
wherein the tag indicates that a fourth text string following the third text string includes the file location identifier.

14. The non-transitory computer-readable medium of claim 13, wherein the file is a portable document file (PDF).

15. The non-transitory computer-readable medium of claim 10, wherein the executable instructions which, when executed by the processor, cause the processor to further:
receive a signal indicative of a timing to update the portion of the file location identifier,
wherein the executable instructions which, when executed by the processor, cause the processor to receive the first text string and open the file responsive to the signal.

16. The non-transitory computer-readable medium of claim 15, wherein receiving the signal is responsive to a change of a location of the file,
wherein the first text string is indicative of a current location of the file.

17. The non-transitory computer-readable medium of claim 15, wherein the second text string is based on an identifier of a user.

18. The non-transitory computer-readable medium of claim 15, wherein the second text string is based on a category.

19. A system comprising:
one or more processors;
a storage comprising:
a data storage configured to store a file; and
a program memory comprising executable instructions to perform a method of modifying information in the file which, when executed by the processor, cause the processor to:
receive a first text string;
open the file including binary data and text data;
read the text data;
detect a file location identifier in the text data;
replace a portion of the file location identifier with a second text string based on the first text string; and
close the file.

20. The system of claim 19, wherein the portion of the file location identifier is indicative of a first file location and the second text string is indicative of a second file location newer than the first file location.

21. The system of claim 19, wherein the portion of the file location identifier is indicative of a temporary path and the second text string is indicative of a permanent path.

22. The system of claim 19, wherein the executable instructions which, when executed by the processor, cause the processor to detect the file location identifier in the text data comprise executable instructions which, when executed by the processor, cause the processor to:
parse the text data into one or more text strings; and
identify a third text string including a tag among the one or more text strings,
wherein the tag indicates that a fourth text string following the third text string includes the file location identifier.

23. The system of claim 22, wherein the file is a portable document file (PDF).

24. The system of claim 19, wherein the executable instructions which, when executed by the processor, cause the processor to further:
receive a signal indicative of a timing to update the portion of the file location identifier,
wherein the executable instructions which, when executed by the processor, cause the processor to receive the first text string and open the file responsive to the signal.

25. The system of claim 24, wherein receiving the signal is responsive to a change of a location of the file,
wherein the first text string is indicative of a current location of the file.

26. The system of claim 24, wherein the portion of the file location identifier is based on an identifier of a user.
